(19) United States
(12) Patent Application Publication
(10) Pub. No.: US 2021/0277710 A1
(43) Pub. Date: Sep. 9, 2021

(54) MOUNTING APPARATUS FOR SECURITY SLIDING BARRIER

(71) Applicant: Meshtec International Co., Ltd., Chiang Mai (TH)

(72) Inventors: David Neil Edlin, Chiang Mai (TH); Peter Syme Taylor, New Farm (AU)

(21) Appl. No.: 17/179,026

(22) Filed: Feb. 18, 2021

Related U.S. Application Data
(60) Provisional application No. 62/978,275, filed on Feb. 18, 2020.

(51) Int. Cl. E06B 9/04; E06B 3/46; E06B 1/36; E06B 1/52

(52) U.S. Cl. CPC E06B 9/04; E06B 3/4609; E05B 15/0205; E06B 1/52; E06B 1/36

(57) ABSTRACT

Disclosed embodiments include a mounting apparatus for a sliding security barrier that includes unique security features that ensure the sliding security barrier is secure and does not suffer problems that exist with conventional security doors and windows. The sliding security barrier is configured to be implemented using tracks that are common to conventional sliding patio screen door or windows. Additional security features include a unique striker plate, a lift protector at a corner, adjustable top and/or bottom channel caps, an interlock, and a uniquely shaped lock. These features provide greater security at a lower cost because they use an existing sliding door or window sash and channels but provide a secure attachment that inhibits tampering and removal of the sliding screen barrier.

### CROSS-REFERENCE TO RELATED APPLICATION

This application claims the benefit of U.S. Provisional Patent Application No. 62/978,275, filed on Feb. 18, 2020, the contents of which is incorporated herein by reference in its entirety.

### BRIEF DESCRIPTION OF THE DRAWINGS

The accompanying drawings are part of this disclosure and are incorporated into the specification. The drawings illustrate example embodiments of the disclosure and, in conjunction with the description and claims, serve to explain various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1A illustrates a perspective cutaway view of a sliding window mounting apparatus encasing an edge portion of a sliding window sash, according to an embodiment.

FIG. 1B illustrates another perspective cutaway view of the sliding window mounting apparatus of FIG. 1A, according to an embodiment.

FIG. 1C illustrates a perspective view of a sliding window mounting apparatus having an upper and lower member and encasing an upper and lower edge portion of a sliding window sash, according to an embodiment.

FIG. 2A illustrates a perspective cutaway view of an upper member encasing an edge portion of a sliding window sash, according to an embodiment.

FIG. 2B illustrates a cross-sectional view of the upper member of FIG. 2A, according to an embodiment.

FIG. 3A illustrates a perspective cutaway view of a lower member encasing an edge portion of a sliding window sash, according to an embodiment.

FIG. 3B illustrates a cross-sectional view of the lower member of FIG. 3A, according to an embodiment.

FIG. 4A illustrates a perspective view of an interlock assembly engaged, according to an embodiment.

FIG. 4B illustrates a cross-sectional view of the interlock assembly of FIG. 4A, according to an embodiment.

FIG. 4C illustrates a perspective view of a first interlock part of the interlock assembly of FIG. 4A affixed to a sliding window sash, according to an embodiment.

FIG. 4D illustrates a top plan view of the first interlock part of FIG. 4C, according to an embodiment.

FIG. 5A illustrates a perspective view of a striker plate affixed to a door jamb, according to an embodiment.

FIG. 5B illustrates an alternative perspective view of the striker plate of FIG. 5A, according to an embodiment.

FIG. 5C illustrates a cross-sectional view of the striker plate of FIGS. 5A and 5B engaged with a locking apparatus, according to an embodiment.

FIG. 5D illustrates a perspective view of the striker plate of FIGS. 5A and 5C ready to receive the locking apparatus, according to an embodiment.

FIG. 5E illustrates another perspective view of FIG. 5D with the striker plate preparing to receive the locking apparatus, the locking apparatus is shown with transparent side portions of its generally U-shaped recess, according to an embodiment.

FIG. 5F illustrates a perspective view of the striker plate of FIG. 5E receiving the locking apparatus and the locking apparatus being vertically slid within the striker plate for locking, according to an embodiment.

FIG. 5G illustrates a perspective view of a striker plate being installed, according to an embodiment.

FIG. 5H illustrates another perspective view of a striker plate being installed having at least one slot, according to an embodiment.

FIG. 5I illustrates a cross-sectional view of the locking apparatus preparing to engage with the slot of the striker plate, according to an embodiment.

FIG. 5J illustrates a top plan view of FIG. 5I, according to an embodiment.

FIG. 5K illustrates another perspective view of a striker plate aligned with a locking mechanism for use on one side of the door frame, according to an embodiment.

FIG. 5L illustrates another perspective view of a striker plate aligned with a locking mechanism for use on an opposing side of the door frame, according to an embodiment.

FIG. 5M illustrates a perspective view of the striker plate of FIG. 5L having at least one slot and receiving the pegs of the locking mechanisms, according to an embodiment.

FIG. 5N illustrates a perspective view of a housing piece of the locking mechanism, according to an embodiment.

FIG. 5O illustrates another perspective view of the housing piece of the locking mechanism, according to an embodiment.

FIG. 5P illustrates a perspective view of the sliding bar mounted to the housing piece of the locking mechanism, according to an embodiment.

FIG. 6A illustrates a perspective view of a lift protector, according to an embodiment.

FIG. 6B illustrates an alternate perspective view of the lift protector of FIG. 6A in use with a sliding window sash, according to an embodiment.

FIG. 7 illustrates a cross-sectional view of a sliding window mounting apparatus having an upper and lower member and encasing an upper and lower edge portion of a sliding window sash and further having adjustable rollers, according to an embodiment.

FIG. 8A illustrates a cross-sectional view of the sliding window mounting apparatus of FIG. 7 having upper and lower members installed on a window sash and the window sash being prepared for insertion by loosening the screws of the adjustable U-channel, according to an embodiment.

FIG. 8B illustrates the window sash having the sliding window mounting apparatus of FIG. 8A being tilted on one end to insert the sash into a frame, according to an embodiment.

FIG. 8C illustrates the window sash having the sliding window mounting apparatus of FIG. 8A being lifted from the other end to adjust the U-channel upward to allow installation into the frame, according to an embodiment.

FIG. 8D illustrates the window sash having the sliding window mounting apparatus of FIG. 8A being straightened from a tilted position on the other end to insert the sash into the frame, according to an embodiment.

FIG. 8E illustrates the window sash having the sliding window mounting apparatus of FIG. 8A being released to release the adjustable U-channel for installation into the frame and the window sash being installed by tightening the screws of the adjustable U-channel, according to an embodiment.

FIG. 9A illustrates an exploded perspective view of the adjustable roller of FIG. 7, according to an embodiment.

FIG. 9B illustrates a side elevation view of the adjustable roller of FIG. 7 in its normal extended position, according to an embodiment.

FIG. 9C illustrates a side elevation view of the adjustable roller of FIG. 7 in its compressed retracted position, according to an embodiment.

FIG. 9D illustrates a front elevation view of the adjustable roller of FIG. 7 in its compressed retracted position, according to an embodiment.

FIG. 10 illustrates a cross-sectional view of a sliding window mounting apparatus having adjustable rollers in use being guided along an unlevel frame, according to an embodiment.

FIG. 11A illustrates a cross-sectional view of a sliding window mounting apparatus having upper and lower members installed on an upper and lower edge of a window sash with adjustable rollers and a non-adjustable housing, according to an embodiment.

FIG. 11B illustrates a cross-sectional view of a sliding window mounting apparatus having upper and lower members installed on an upper and lower edge of a window sash with adjustable rollers and a non-adjustable housing, according to an embodiment.

FIG. 12A illustrates a window sash having mounted thereon the sliding window mounting apparatus of FIG. 11B, the window sash being prepared for insertion by aligning the upper and lower members of the apparatus with the frame, according to an embodiment.

FIG. 12B illustrates the window sash of FIG. 11B being tilted to insert into the upper portion of the frame, according to an embodiment.

FIG. 12C illustrates the window sash of FIG. 11B being lifted from the lower edge and compressing the upper adjustable rollers into a retracted position to allow insertion of the entire window sash into the frame, according to an embodiment.

FIG. 12D illustrates the window sash of FIG. 11B being rotated into a straightened vertical position to insert the window sash into the frame, according to an embodiment.

FIG. 12E illustrates the window sash of FIG. 11B being released to move the upper adjustable rollers into their normal extended position and releasing the lower edge of the sash down to engage the lower portion of the frame.

### DETAILED DESCRIPTION

This disclosure relates to a mounting apparatus for a security sliding barrier such as a window or door. The disclosed mounting apparatus may also be used with other securing sliding barriers including any other structure that is on a track and configured to slide on the track.

Sliding barriers, such as sliding doors or windows conventionally come encased in a sash that slides along tracks installed in a frame or entryway. These sliding barriers are particularly vulnerable to failure or unauthorized entry. Some sliding doors may simply be lifted off the tracks to provide a point of entry into a dwelling. Other sliding doors may be made of structurally weak materials so that the door bends or easily gives upon the application of force. A common complaint in the door and window industry is having flimsy screens coming off the tracks and offering no security, this concept covers both of those issues.

Conventional solutions for securing sliding doors include adding additional locks or latches, replacing the existing locks, or adding bars on the tracks to limit the slidability of the doors. But most of these existing solutions involve the use of the existing sash and tracks because they are already permanently attached to the frame of the home and are difficult to remove and replace. Security sliding doors that include mesh materials and those that do not are different from conventional insect screens and sliding glass doors and windows in that the mesh, door and window materials are more durable and resistant to penetration. Other solutions to strengthen the security features of a sliding door or window system include entirely replacing the sliding doors with more structurally sound doors as well as the tracks on which the sliding doors slide. But replacing the doors and windows and the existing tracks on which the sliding doors and windows slide can be expensive.

According to an embodiment, a sliding screen barrier is implemented to use existing sliding patio screen door or window tracks that are common to all conventional sliding patio screen door or windows. However, unique security features are added to ensure the sliding screen barrier is secure and does not suffer the same problems that exist with conventional security doors and windows. Additional security features include, but are not limited to, a unique striker plate, a lift protector at the corner, adjustable top and/or bottom channel caps, an interlock and a uniquely shaped lock. As described more fully below, one or more of these features provides for greater security at a lower cost because they use the existing sliding door or window sash and channels, but provide secure attachment and restricted removal of the sliding screen barrier.

According to an embodiment, there is provided a sliding window mounting apparatus having a housing with an inner side opposing an outer side. A generally U-shaped channel runs along the inner side of the housing for receiving an edge portion of a sliding window sash. At least one roller extends from the outer side for slidingly engaging a track.

In another embodiment, there is a provided a security sliding door having an upper member and a lower member for engaging a respective upper and lower edge portion of a sliding window sash. Each member has a housing having a generally U-shaped channel running along an inner side of the housing for engaging the respective upper and lower edge portions of a sliding window sash. Each member has at least one roller extending from an outer side of the housing that opposes the inner side of the housing, for slidingly engaging a respective upper and lower track.

An interlock assembly is also provided on the security sliding door having a first interlock part secured to a fixed panel such as a window or door frame and having a second interlock part secured to the sliding window sash for engagement with the first interlock part upon slidably closing the sliding window to limit lateral movement of the security sliding door.

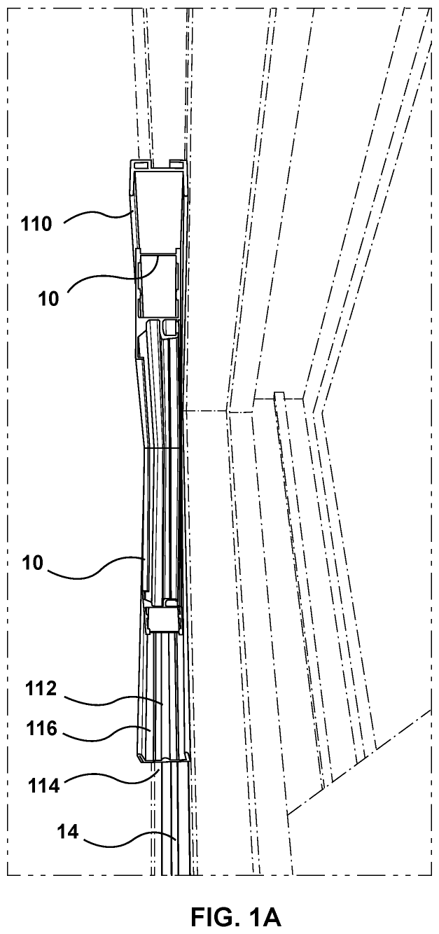

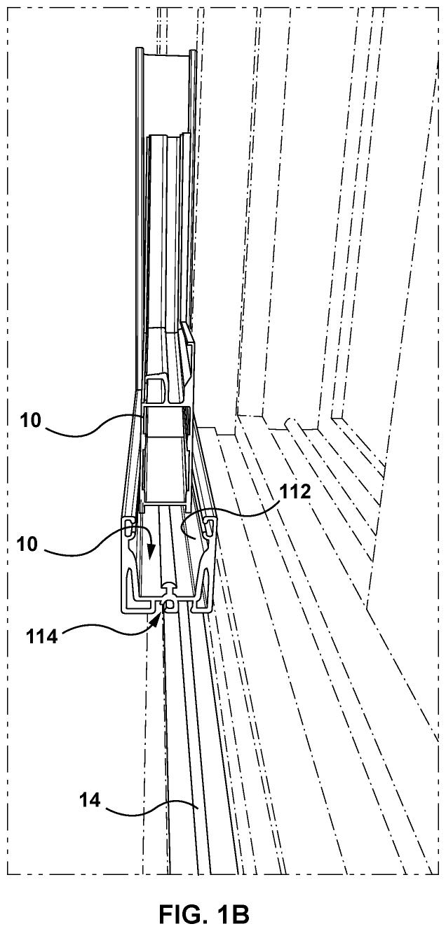

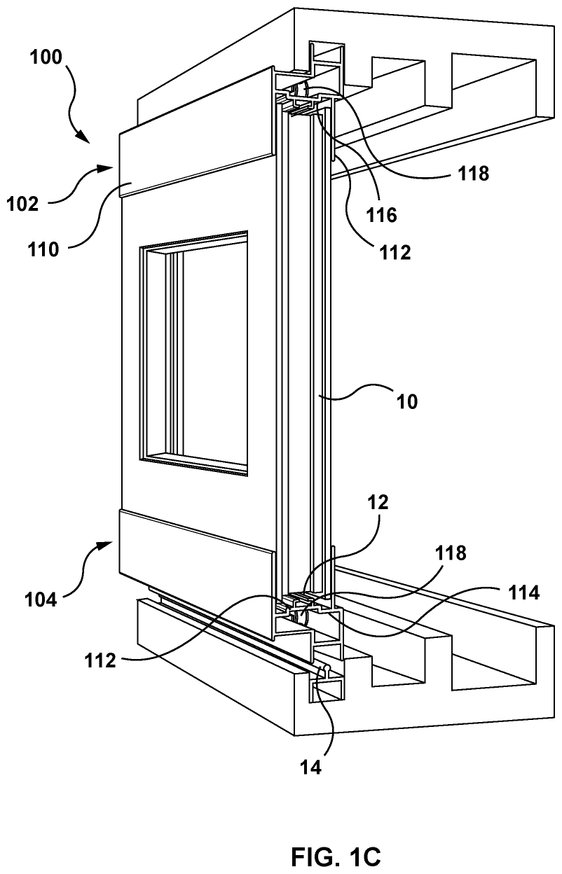

Making reference to FIGS. 1A-3B, in one aspect of the disclosure, a sliding window mounting apparatus 100 is provided for engaging an edge portion 12 of a sliding door sash 10. The sliding window mounting apparatus 100 has a housing 110 having an inner side 112 opposing an outer side 114. A generally U-shaped channel 116 may run along the inner side 112 of the housing 110 for receiving an edge portion 12 of a sliding window sash 10. At least one roller 118 extends from the outer side 114 for slidingly engaging the track 14.

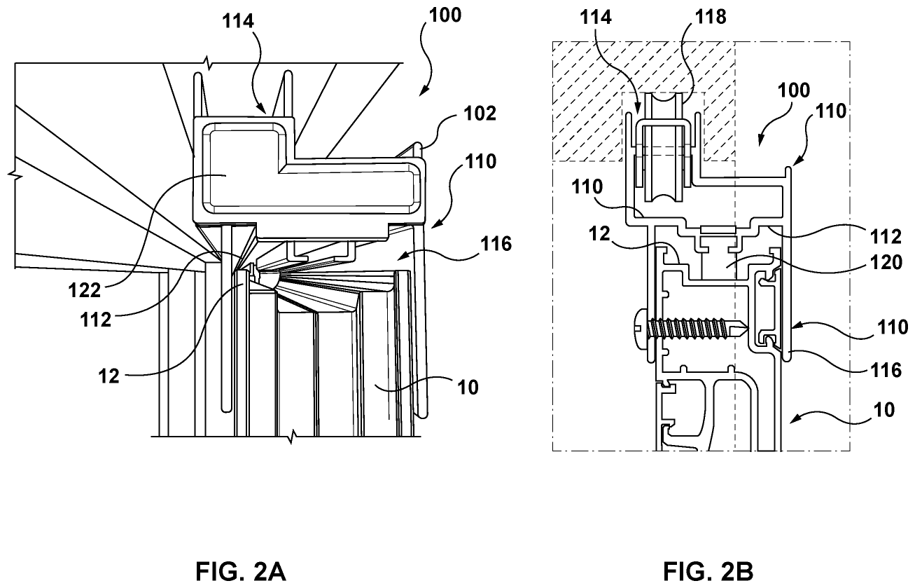

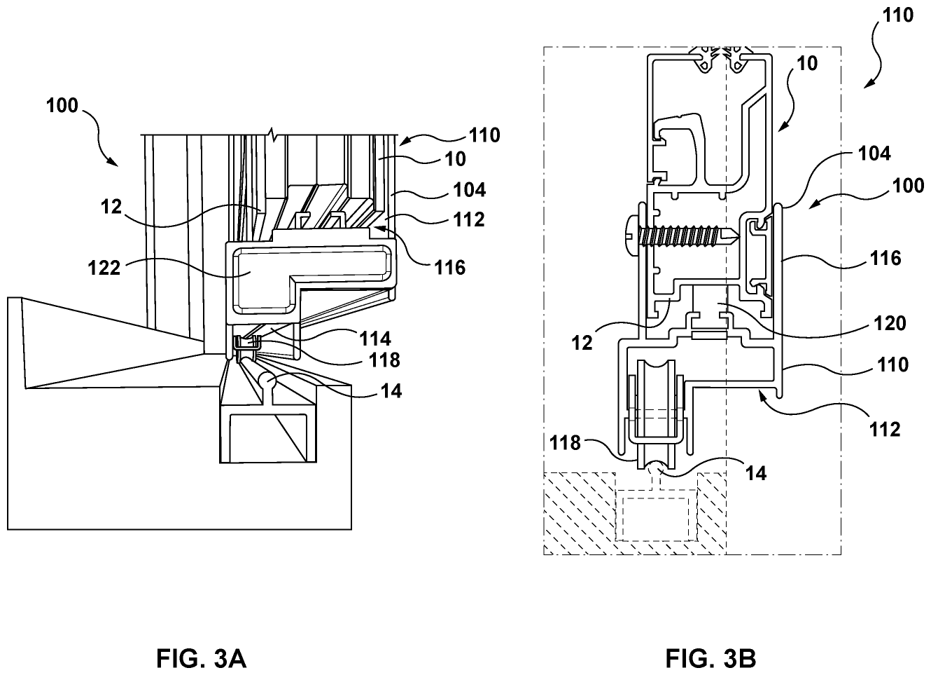

The generally U-shaped channel 116 running along the inner side 112 of the housing 110 slides over an edge of the sliding window sash 10 such as a sliding door or sliding screen door. It is guided over the sliding window sash 10 and may be secured to the sliding window sash 10 by a fastener such as a threaded screw as shown, for example, in FIGS. 2B and 3B. Although only one screw is shown, in actuality, a number of fasteners of various sizes would be used as will be known to one with skill in the art.

To engage an existing track 14, rollers 118 may extend from the outer portion 114 as shown, for example, in FIGS. 2B-3B. The roller 118 may be a wheel having a channeled surface for engaging a protrusion forming a track 14 as shown in the accompanying drawings. Alternatively, the roller may be configured differently, such as having multiple channeled surfaces to align with and engage multiple protrusions of a track. Any suitable number and configuration of rollers can be used as will be known to one with skill in the art. Typically, at least two spaced apart rollers would be used for stability. Additionally, alternative roller options are available such as adjustable rollers, fixed rollers, or larger rollers that can offer improved security. Particular embodiments of these may be used and described further below.

To provide for adjustability within the sliding window mounting apparatus 100, springs may be provided, such as flat springs 120 between the sliding window sash 10 and the inner side 112 of the U-shaped channel 116. During installation, this is helpful to guide the sliding window mounted with the sliding window mounting apparatus 100 onto tracks 14. For example, as described below, in use, the sliding window mounted with the sliding window mounting apparatus 100 is inserted onto existing upper and lower tracks 14. Therefore, after the sliding window is guided onto one set of tracks 14, the flat springs 120 permit for adjustability or compression of the sliding window to allow it to be inserted onto opposing tracks 14 before eventually releasing. The flat springs 120, therefore, permit sufficient clearance for guiding and installing the sliding window after it the sliding window mounting apparatus 100 is installed.

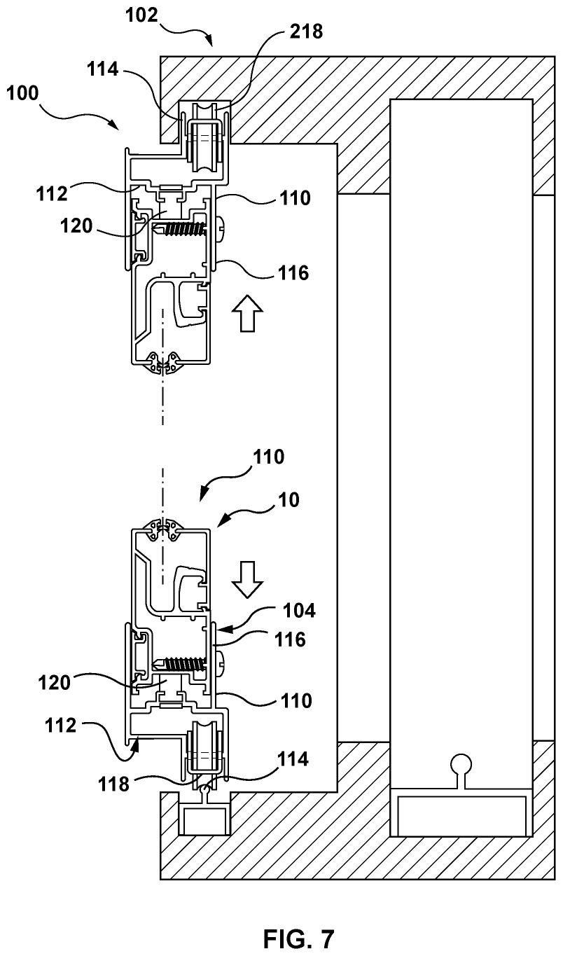

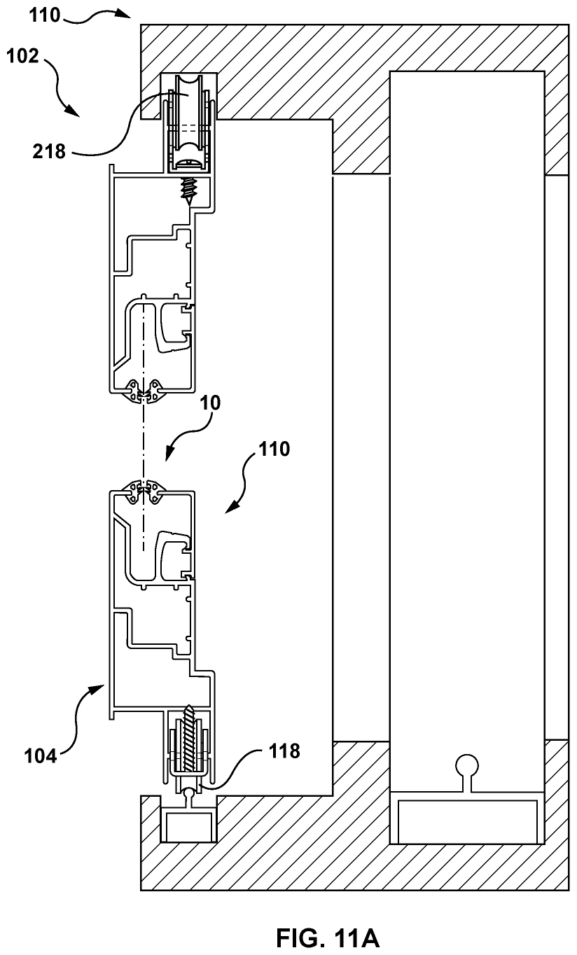

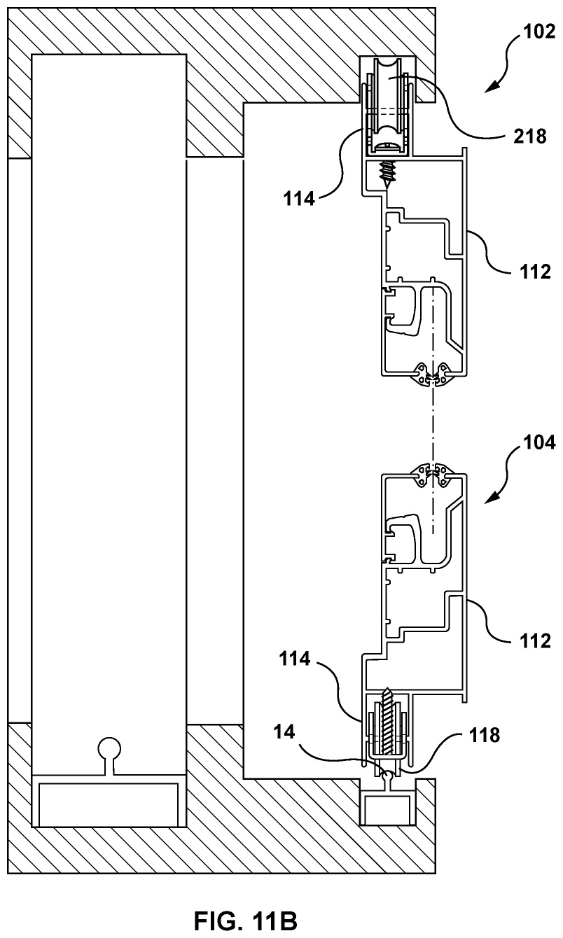

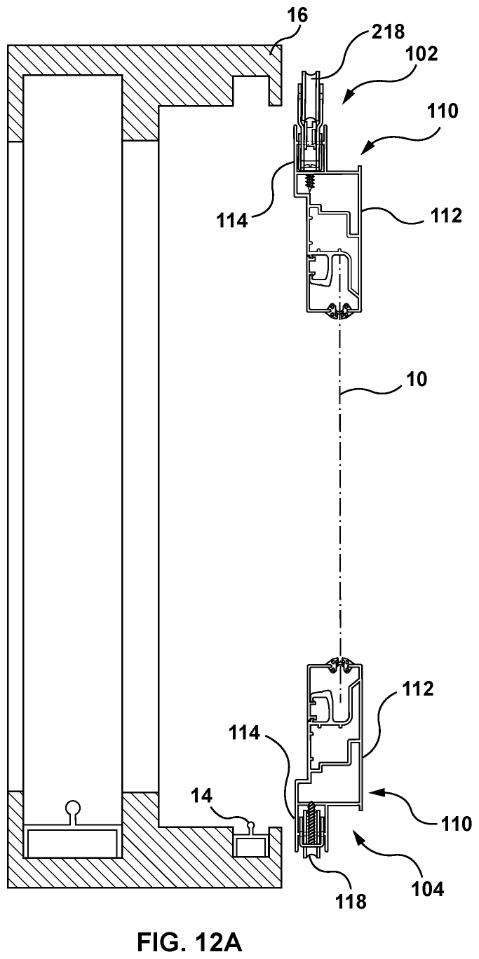

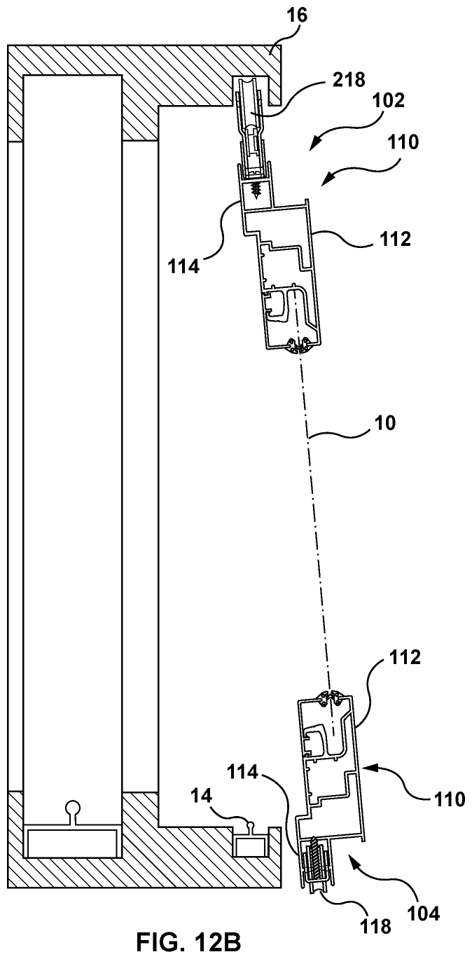

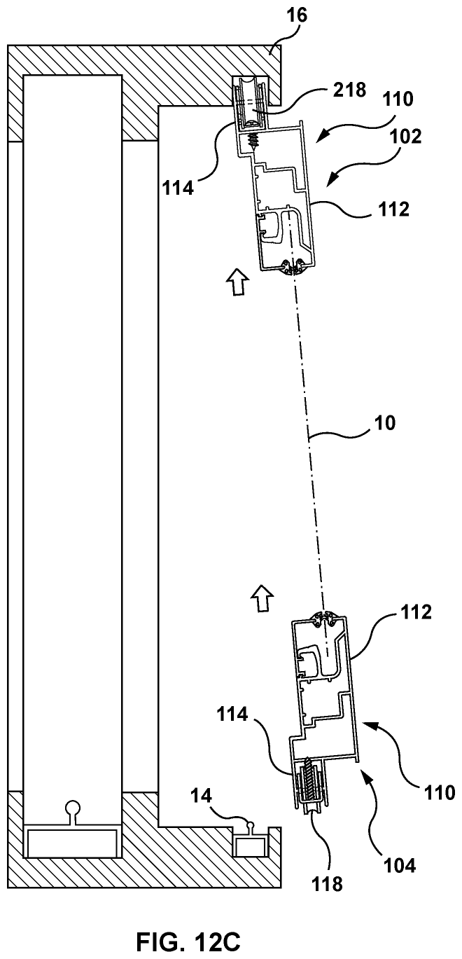

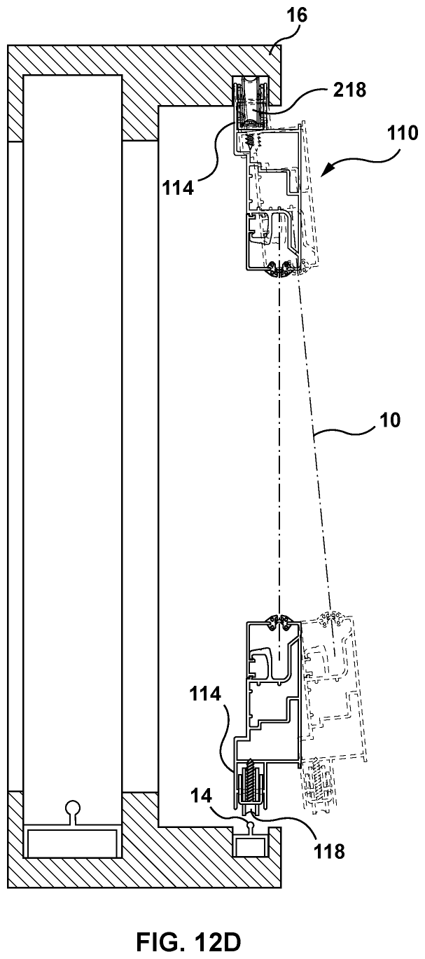

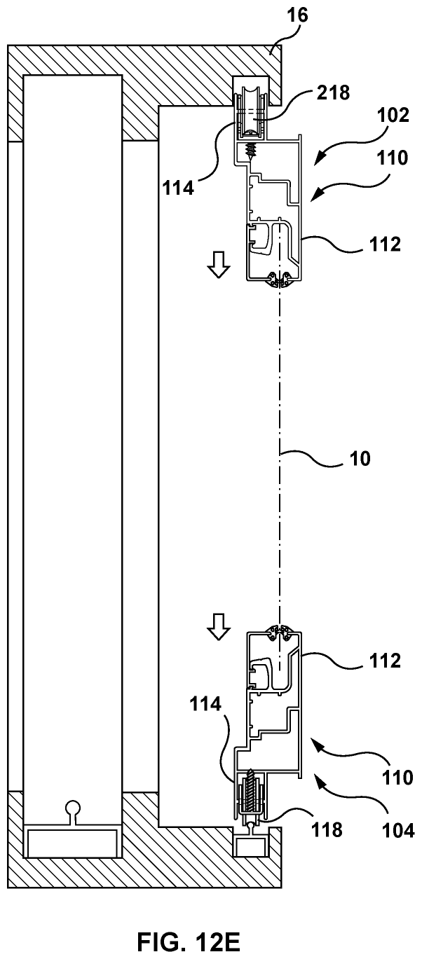

In yet another embodiment, the housing 110 may be fixed with no further adjustable U-channel as shown in, for example, FIGS. 11A-12E. In those instances, to allow installation for the window sash 10 within the frame 16, adjustable rollers 218 may be provided as shown in the accompanying figures. These rollers may be further adjustable 218 in addition to an adjustable U-channel housing as shown, for example, in FIGS. 7-10, or may be adjustable in lieu of the adjustable U-channel housing as shown, for example, in FIGS. 11-12E. For example, the adjustable rollers 218 may include a return spring 220 so that the adjustable rollers 218 remain in an expanded position and retract as guided by the frame and/or tracks. This adjustability can be useful during insertion of the window sash 10 into the frame 16 as well as to permit continuous rolling in case the frame 16 is not level. As shown, the rollers engaging the upper portion of the frame may be adjustable while the rollers engaging the lower portion of the frame (or track) may be fixed. In other embodiments, the upper and lower rollers may be adjustable or other combinations of adjustability as will be known to one with skill in the art.

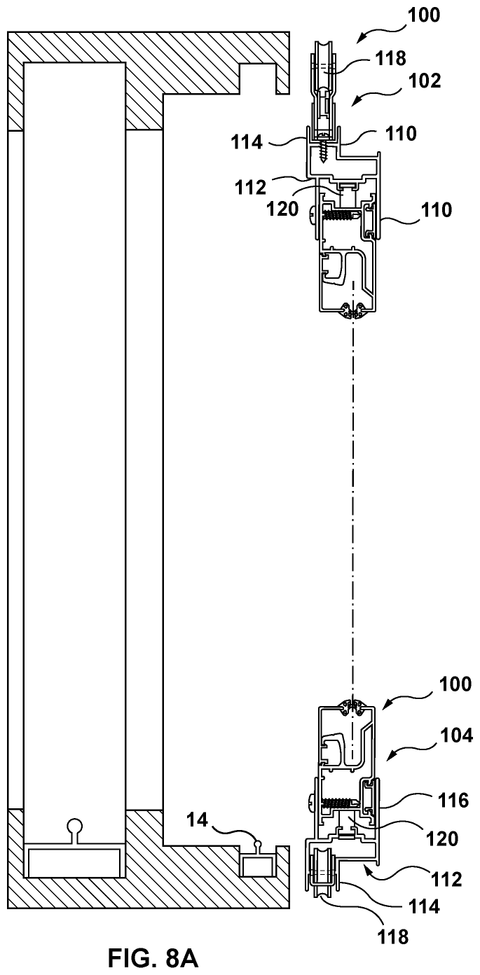

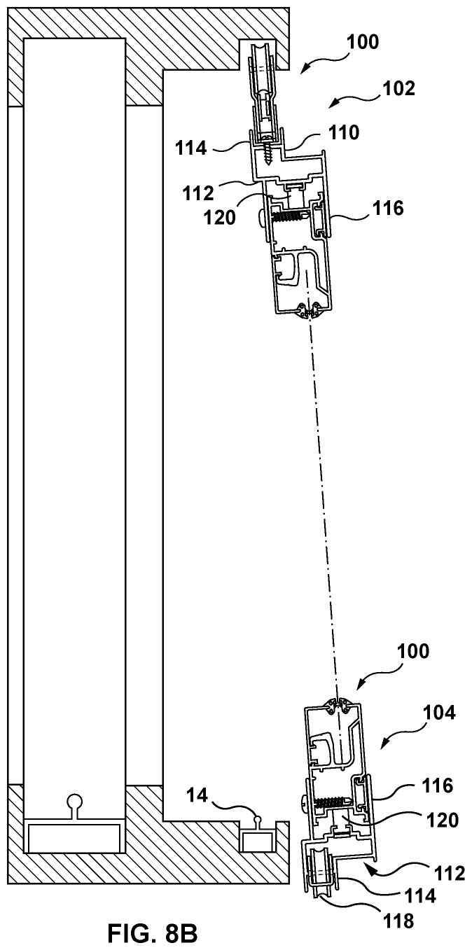

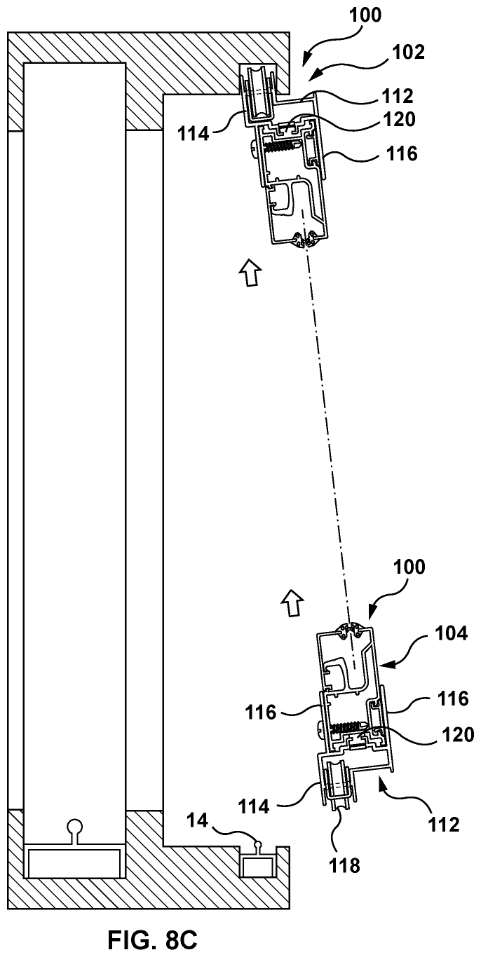

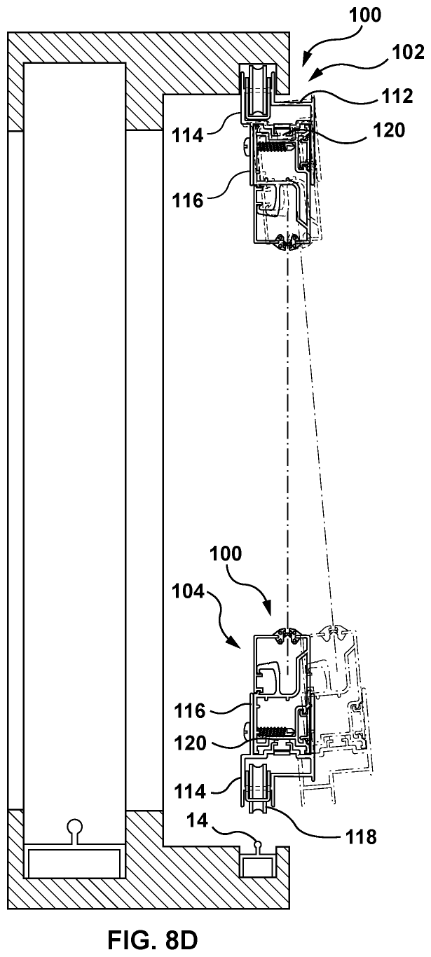

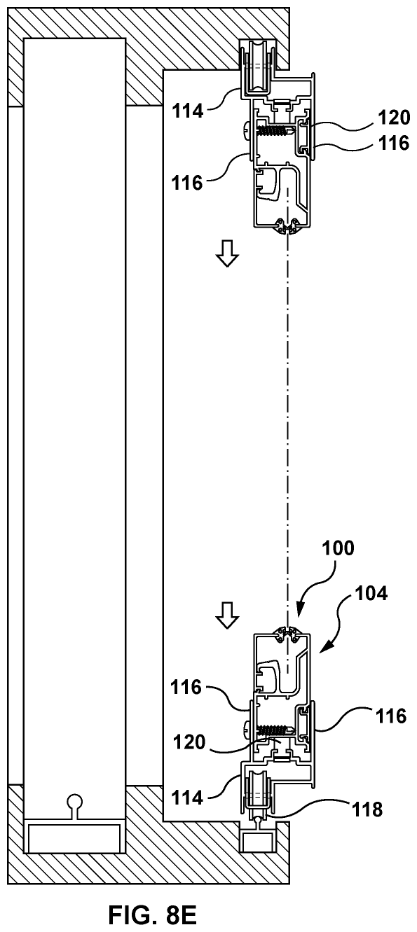

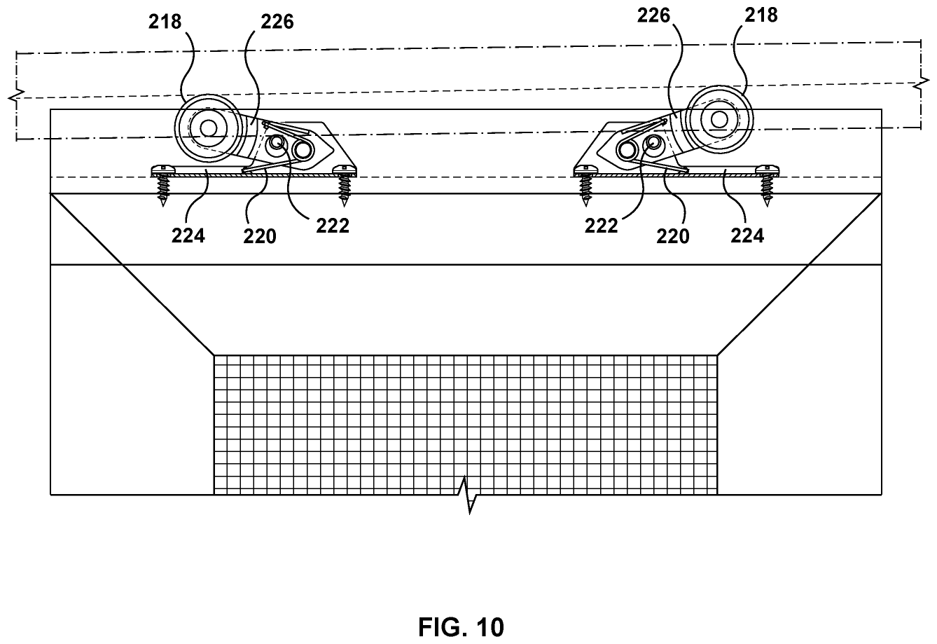

In one embodiment of the adjustable roller 218, a base 224 having a generally U-shaped cradle is provided that can be secured to the frame 16, by a fastener or screws or as will be known to one with skill in the art. A handle 226 is retained to the generally U-shaped base 224 at one end to permit the handle 226 to rotate within the base to an extended or retracted position. Adjustable rollers 218 are mounted at another end of the handle 226. The return spring 220 may be added by being secured, for example, to a retaining ring extending through aligned slots in the U-shaped cradle of the base 224 and the one end of the handle 226. Therefore, when the handle 226, normally in an extended position, is compressed into a retracted position, the handle biases toward the extended position to maintain rolling within the frame 16, as shown, for example, in FIG. 10. This adjustability or extension/retraction is also useful during installation of the sliding window sash 10 into the frame 16 as shown, for example, in FIGS. 8A-8E.

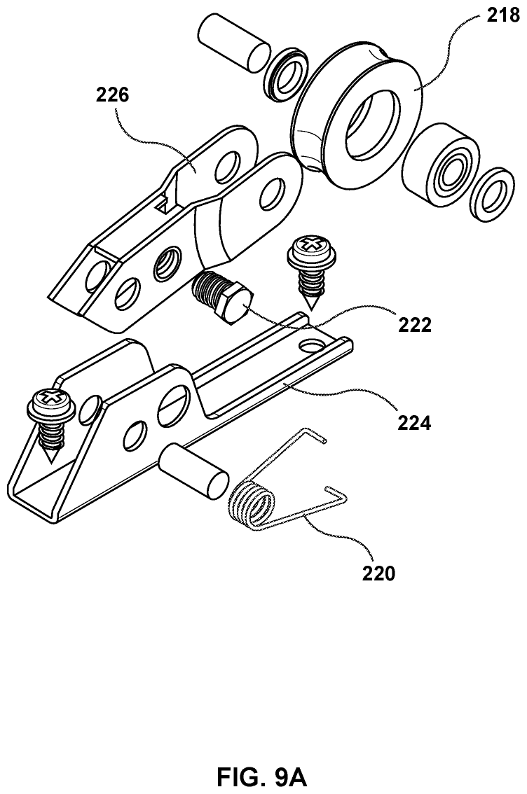

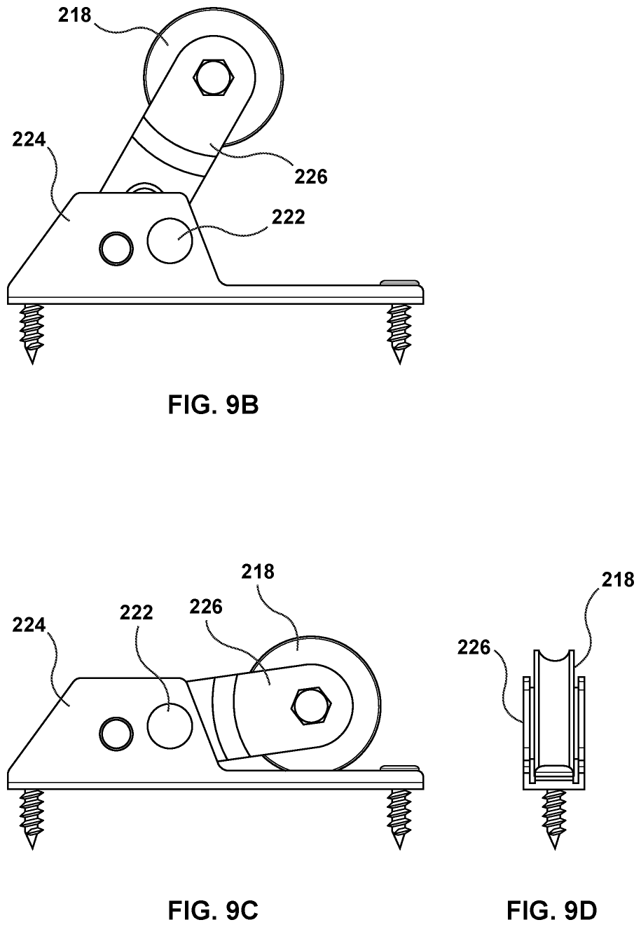

Once the sliding window sash with the sliding window mounting apparatus is installed, it may be desirable to limit the sash's 10 removal to improve security. Therefore, a locking screw 222 may be added to the adjustable rollers (FIG. 9B-9C). In use, the adjustable rollers vertically adjust as shown, for example, in FIGS. 8A-8E for installation, and may then be locked in place with the insertion of the locking screw 222 in a corresponding hole (as shown in, for example, FIGS. 9A-10). Thus, when the adjustable roller is in its desired position, the locking screw 222 may be inserted to secure that position to limit further vertical movement and limit lifting of the door or sash 10 from the frame 16. In one embodiment, the locking screw 222 may be sized smaller than the corresponding hole to permit limited vertical movement or adjustability within the frame, for example, for a frame 16 that is not level as shown in FIG. 10 without permitting the full range of movement that would otherwise be available without the locking screw 222, and thereby continuing to offer increased security.

Although the housing 110 is shown to have an internal profile with various grooves and extensions, the internal profile can have various other features to generally complement the external profile of a sliding door as will be known to one with skill in the art.

Optionally, an end plug 122 may be added to cover the outer side 114 of the housing 110. This can improve the cosmetic appearance of the housing 114 and limit the entry of dust or other debris into outer side 114 of the sliding window mounting apparatus 100. Limiting the entry of dust and debris into the outer side 114 of the housing 110 can also help keep the rollers 118 clean to maintain the rolling of the sliding windows on the tracks 14 as will be known to one with skill in the art.

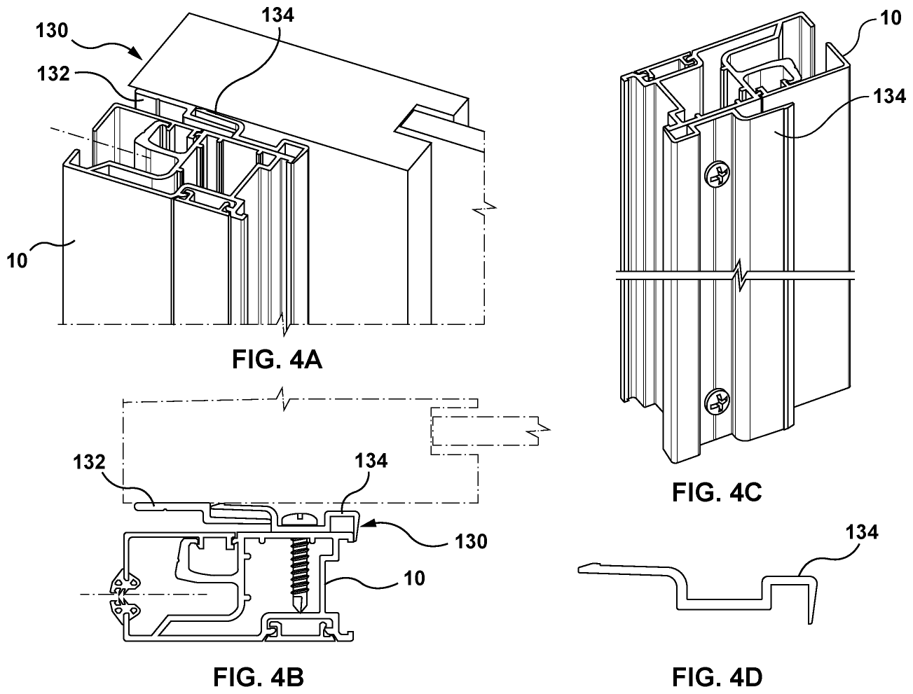

In another embodiment, as shown in FIGS. 4A-4D, the sliding window mounting apparatus 110 has an interlock assembly 130 having a first interlock part 132 secured to a fixed panel, such as the frame of a doorway or window, and a second interlock part 134 secured to the sliding window sash 10 for engagement with the first interlock part 132 upon slidably closing the sliding window 10.

The first and second interlock parts 132, 134 may be secured to their respective surfaces with a fastener such as a screw. These screws may be spaced apart along the first and second interlock parts 132, 134 as will be known to one with skill in the art. When engaged, the interlock assembly limits lateral movement of the sliding door 10 to restrict removal of the sliding door 10 from the sliding window sash 10. An upper member 102 and a lower member 104 may be provided for the sliding window mounting apparatus, each engaging an upper and lower edge portion 12 of the sliding window sash 10. Therefore, the interlock assembly 130 may extend between both the upper and lower members 102, 104. Although FIGS. 4A-4D illustrate a particular shaped interlock component, it will be clear to those of ordinary skill in the art that the specific shape of the interlock components may be modified for other embodiments provided they proved the interlocking function. By non-limiting example, an L-shaped interlock is also contemplated.

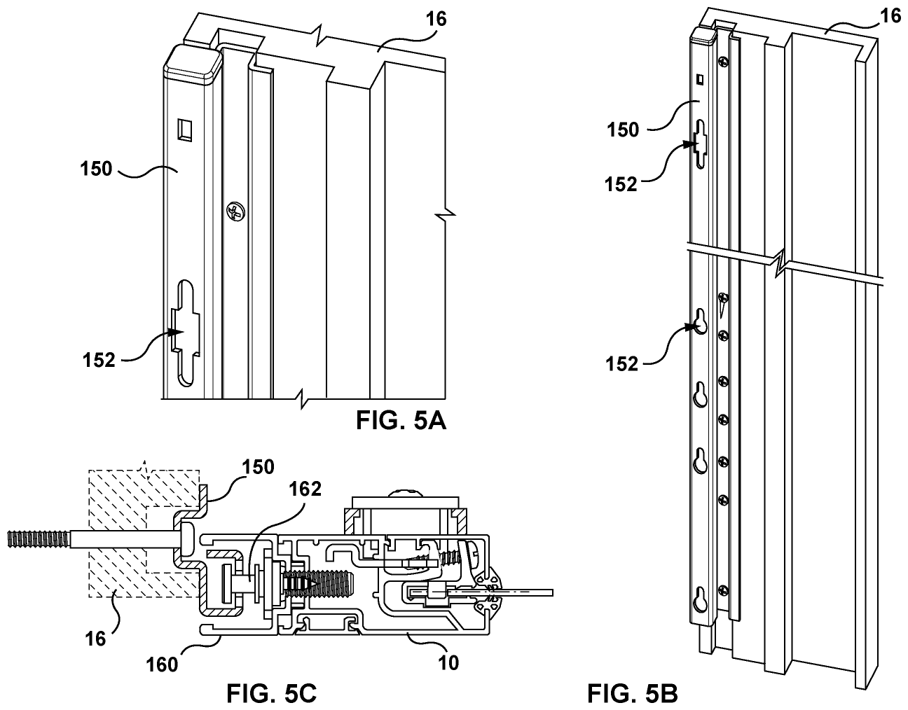

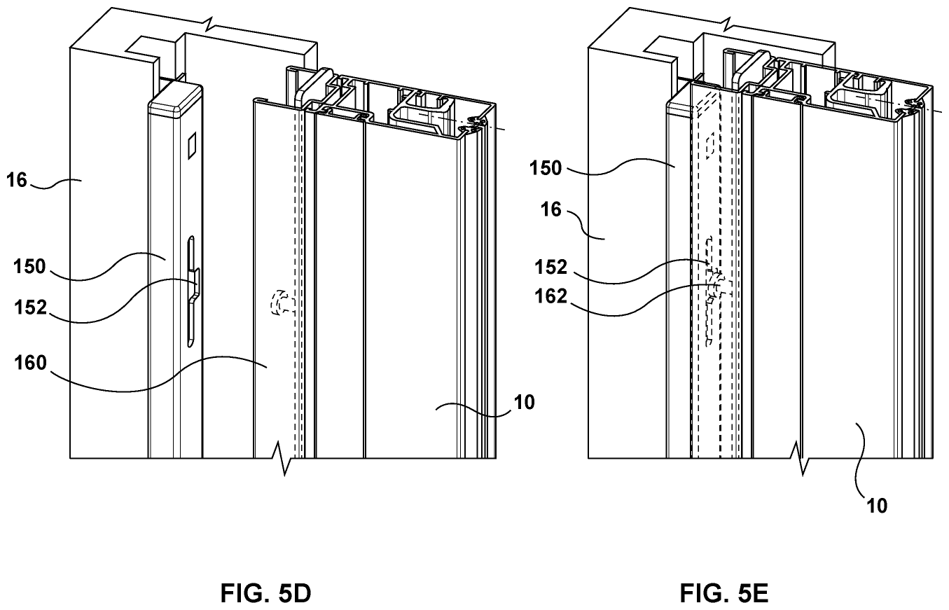

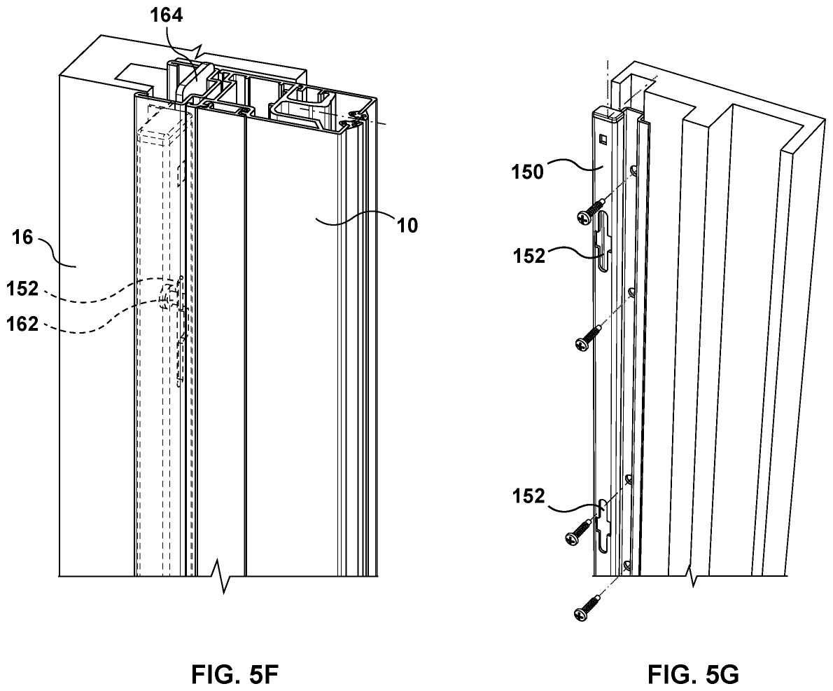

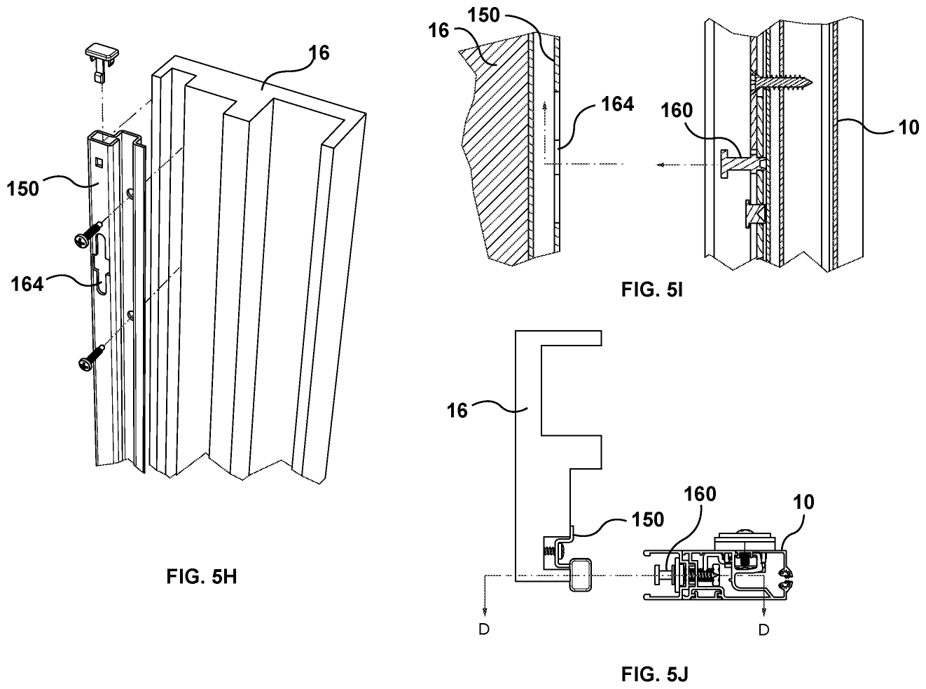

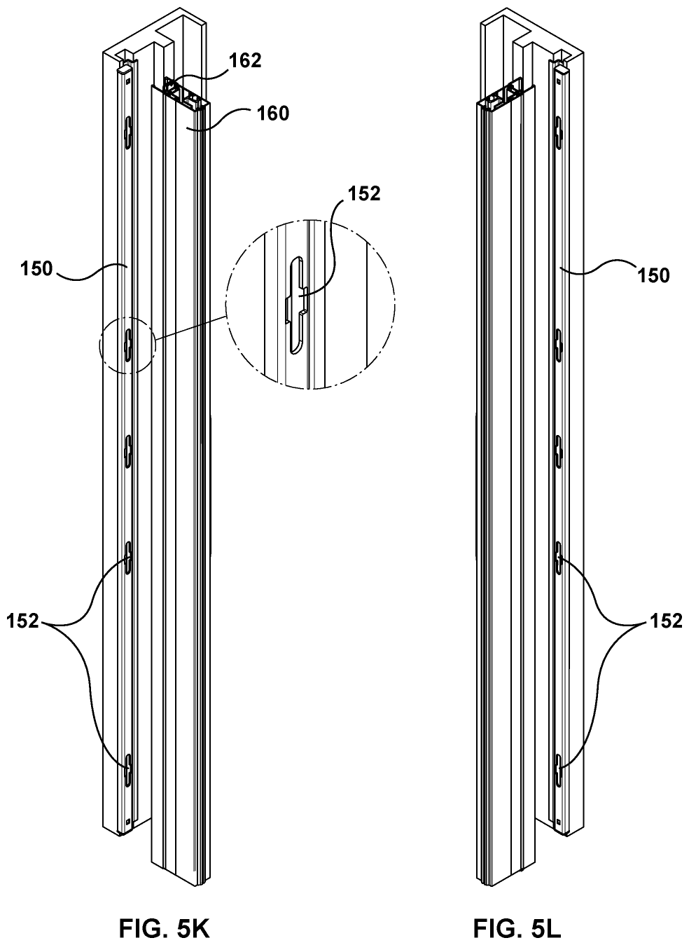

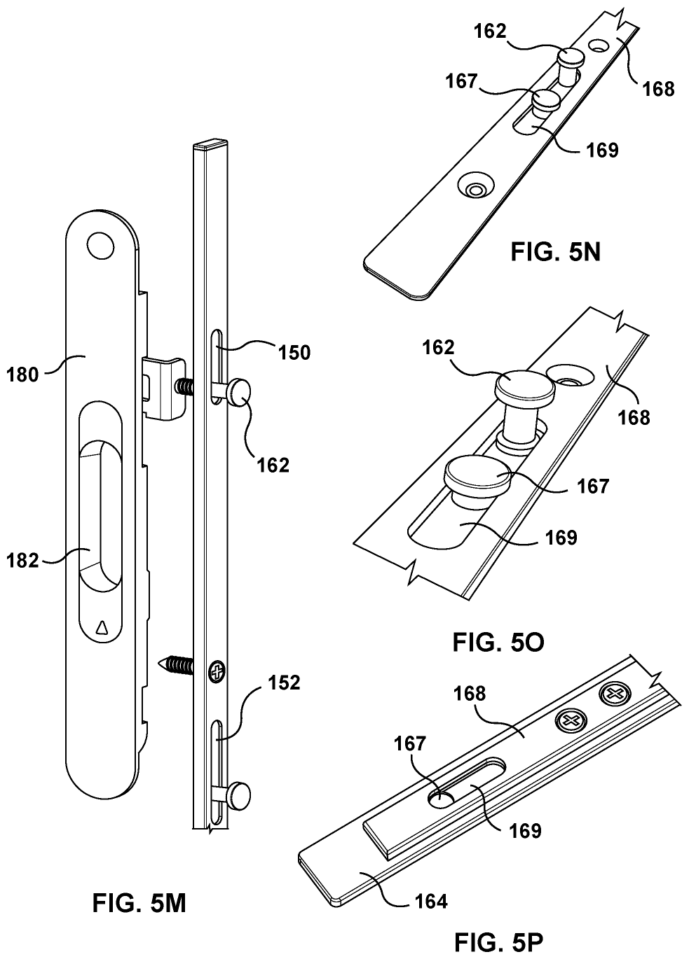

Now making reference to FIGS. 5A-5P, in a further embodiment, a striker plate 150 is secured to a door jamb or frame 16 for providing a striking surface for the sliding window sash 10 when closed. A locking apparatus 160 is mounted to an edge of the sliding window sash 10, the locking apparatus 160 having at least one locking peg 162 that extends toward the striker plate 150. At least one slot 152 is provided within the striker plate 150 that aligns with and receives the at least one locking peg 162 from the sliding window sash 10. The locking apparatus 160 has a housing with a generally U-shaped recess 166 for receiving the striker plate 150. The side portions of the U-shaped recess 166 embrace the sliding window sash 10 when closed, and the slots 152 of the striker plate 150 receive the pegs 162 of the locking apparatus 160.

The striker plate 150 may be of unitary construction as shown in the accompanying figures or it may be composed of multiple parts so long as the at least one slot 152 aligns with the at least one locking peg 162.

In one example, the least one locking peg 162 is a mushroom head peg vertically slidable relative to the window sash to removably lock the mushroom head peg into the slot 152 as shown. Therefore, the slot 152 may be as shown in FIG. 5H with an expanded center for receiving the mushroom head peg 162. Alternatively, any portion of the slot 152, such as the bottom portion, may be expanded for receiving the mushroom head peg 162. A sliding portion 164 of the locking apparatus 160 may then be lifted to slide the mushroom head pegs 162 within the slots 152 when received to a narrower portion of the slot 152. Once slid, for example, upwardly, as shown in FIG. 5F, the mushroom head peg 162 is effectively limited from being pulled out of the slot 152 given the narrower portion of the slot 152. To disengage, the sliding portion 164 of the locking apparatus 160 can be vertically slid in an opposing direction until the mushroom head peg 162 aligns with the expanded portion of the slot 152 such that it can then be removed when the door is pulled open.

The sliding portion 164 may, for example, be a slidable bar 164 as shown in the accompanying figures. The slidable bar 164 may be slidably mounted to a housing piece 168 at the bottom of the U-shaped recess 166 of the locking apparatus 160. To allow slidable mounting, the slidable bar 164 is engaged in slot openings 169 of the housing piece 168 with a fastener 167 extending into the housing 168 and sash. Although any suitable fastener can be used, such as a pin 167 as shown in the accompanying drawings, it would have a head wider than the slot openings 169 to allow engagement and sliding.

Thus, as shown in the drawings, when the sliding window is closed, the mushroom head pegs 162 of locking apparatus 160 align with and engage the slots 152 of the striker plate 150. To lock, a handle 180 may be provided on the locking apparatus 160 which has a user-facing guide 182 connected to the interior slidable bar 164. When, for example, moved up or down, the guide 182 moves or slides the interior slidable bar 164 such that the mushroom head pegs 162 located on the slidable bar 164 move along with the slidable bar 164 to lock within the slots 152 of the striker plate 150. The slidable bar 164 is located under the housing piece 168 so that housing piece 168 holds the slidable bar 164 in place. The mushroom head pegs 162 extend from the slidable bar 164 through the slot openings 169 of the housing piece 168 to allow movement or sliding.

Although only one slot 152 is shown, for example, in FIG. 5H, any number of slots may be provided as shown, for example, in FIGS. 5B, 5K and 5L. The locking apparatus 160 may have a complementary number of locking pegs 160, and the locking pegs 160 would be aligned to engage with the slots 152.

In another embodiment, a different locking system is envisioned other than the mushroom head pegs 162 and slots 152 described above. For example, a combination of hooks and eyes, latches and receivers or any other locking system as will be known to one with skill in the art may be used.

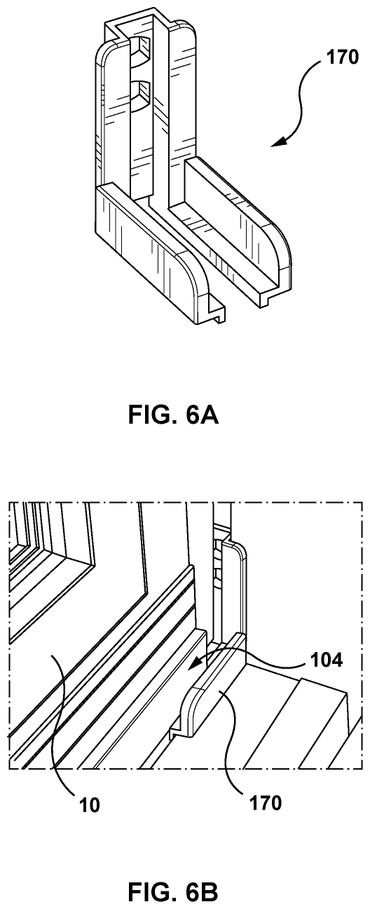

In still another embodiment, a generally L-shaped lift protector 170 may be provided that is securable to a corner of a frame 16 in which the sliding window sash 10 is receivable to inhibit removal of the sliding window from the track 14. When closed, the L-shaped lift protector engages a corner of the sliding window mounting apparatus 100 to limit removal of the sliding window from the track 14, as shown, for example, in FIGS. 6A and 6B. The lift protector 170 may be inserted around the corner of the sliding window mounting apparatus 10 so that the elbow of the L-shaped lift protector 170 cradles the corner of the sliding window mounting apparatus 100. This can simply be slid around the corner or may be further reinforced with fasteners such as screws. When engaged with the housing 110, the L-shaped lift protector 170, prevents access to the edge of the housing 110 with a prying tool, providing further security.

In use, this disclosure provides for the replacement of the sliding door with a security sliding door that includes an upper member 102 and a lower member 104 each engaging an upper and lower edge portion 12 of a sliding window sash 10. Each of the upper and lower members, 102, 104, has a housing 110 having a generally U-shaped channel 116 running along an inner side 112 of the housing 110 for receiving a respective upper and lower edge portion 12 of the sliding window sash 10. Each of the upper member 102 and lower member 104 has at least one roller 118 or 218 extending from an outer side 114 that opposes the inner side 112 of the housing 110 for slidingly engaging the upper and lower tracks 14. The upper and lower members 102 and 104 can have the features as described above such as an interlocking assembly 130, or striker plate 150 and locking apparatus 160 combination, and/or a lift protector 170.

One or more embodiments have been described by way of example. It will be apparent to persons skilled in the art that a number of variations and modifications can be made without departing from the scope of the disclosure.

It will be understood that implementations of the mounting apparatus for a sliding security barrier include but are not limited to one or more of the specific components disclosed herein, as virtually any components consistent with the intended operation of various mounting apparatus for a sliding security barrier may be utilized. Accordingly, for example, it should be understood that, while the drawings and accompanying text show and describe particular powered wall plate attachment implementations, any such implementation may include any shape, size, style, type, model, version, class, grade, measurement, concentration, material, weight, quantity, and/or the like consistent with the intended operation of a mounting apparatus for a sliding security barrier.

The concepts disclosed herein are not limited to the specific mounting apparatus for a sliding security barrier shown herein. For example, it is specifically contemplated that the components included in various mounting apparatus for a sliding security barrier may be formed of any of many different types of materials or combination that can readily be formed into shaped objects and that are consistent with the intended operation of the mounting apparatus for a sliding security barrier. For example, the components may be formed of: rubbers (synthetic and/or natural) and/or other like materials; glasses (such as fiberglass), carbon-fiber, aramid-fiber, any combination thereof, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, allow steel, tool steel, stainless steel, spring steel, aluminum, and/or other like materials; and/or any combination of the foregoing.

Furthermore, mounting apparatus for a sliding security barrier may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending, among other considerations, the particular material(s) forming the components.

In places where the description above refers to particular mounting apparatus for a sliding security barrier implementations, it should be readily apparent that a number of modifications may be made without departing from the spirit thereof and that these implementations may be applied to other implementations disclosed or undisclosed. The presently disclosed embodiments for a mounting apparatus for a sliding security barrier are, therefore, to be considered in all respects as illustrative and not restrictive.

This disclosure, and implementations, are not limited to the specific material types, components, methods, or other examples disclosed herein. Many additional material types, components, methods, and procedures are contemplated for use with particular implementations from this disclosure. Accordingly, for example, although particular implementations are disclosed, such implementations and implementing components may include any components, models, types, materials, versions, quantities, and/or the like as is for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is appreciated that a myriad of additional or alternate examples of varying scope could have been presented, but have been omitted for purposes of brevity.

While this disclosure includes a number of implementations in many different forms, there is shown in the drawings and will herein be described in detail particular implementations with the understanding that the disclosure is to be considered as an exemplification of the principles of the disclosed methods and systems, and is not intended to limit the broad aspect of the disclosed concepts to the implementations illustrated.

### PARTS LIST

| | |
|---|---|
| 10 | sliding window sash |
| 12 | edge portion |
| 14 | track |
| 16 | frame |
| 100 | sliding window mounting apparatus |
| 102 | upper member |
| 104 | lower member |
| 110 | housing |
| 112 | inner side |
| 114 | outer side |
| 116 | U-shaped channel |
| 118 | roller |
| 120 | flat spring |
| 122 | end plug |
| 130 | interlock assembly |
| 132 | first interlock part |
| 134 | second interlock part |
| 150 | striker plate |
| 152 | at least one slot |
| 160 | locking apparatus |
| 162 | at least one locking peg |
| 164 | sliding portion |
| 166 | U-shaped recess |
| 167 | fastener |
| 168 | housing piece |
| 169 | slot openings |
| 170 | lift protector |
| 180 | handle |
| 182 | guide |
| 218 | adjustable roller |
| 220 | return spring |
| 222 | locking screw |
| 224 | base |
| 226 | handle |

What is claimed is:

1. A sliding window mounting apparatus, comprising:
a housing having an inner side opposing an outer side;
a channel running along the inner side configured to receive an edge portion of a sliding window sash; and
at least two rollers extending from the outer side configured to slidingly engage a track.

2. The sliding window mounting apparatus of claim 1, wherein the channel is vertically adjustable.

3. The sliding window mounting apparatus of claim 1, wherein at least one roller is vertically adjustable.

4. The sliding window mounting apparatus of claim 1, further comprising an interlock assembly having a first interlock part secured to a fixed panel and having a second interlock part secured to the sliding window, the second interlock part configured to engage the first interlock part upon slidably closing the sliding window.

5. The sliding window mounting apparatus of claim 1, further comprising:
a striker plate configured to be secured to a door jamb to thereby provide a striking surface for the sliding window sash when closed; and
a locking apparatus mounted on an edge of the sliding window sash, the locking apparatus having at least one locking part extending toward the striker plate,
wherein the striker plate includes at least one receiver aligned with the locking part, the receiver configured to receive the at least one locking part from the sliding window sash, and
wherein the at least one locking part is vertically slidable relative to the window sash to removably lock the locking part into the receiver.

6. The sliding window mounting apparatus of claim 5, wherein the at least one locking part is a locking peg and the at least one receiver is a slot.

7. The sliding window mounting apparatus of claim 6, wherein the locking peg has a mushroom headed configuration.

8. The sliding window mounting apparatus of claim 5, wherein the at least one locking part is a hook, and the at least one receiver is an eye.

9. The sliding window mounting apparatus of claim 1, further comprising a generally L-shaped lift protector configured to be secured to a corner of a frame into which the sliding window sash is receivable, the lift protector configured to inhibit removal of the sliding window from the track by preventing insertion of a tool beneath the sash.

10. A security sliding door, comprising:
an upper member including a first housing having a generally U-shaped channel running along an inner side of the housing configured to receive an upper edge portion of a sliding window sash,
wherein the first housing includes at least one roller extending from an outer side opposing the inner side of the first housing, the roller configured to slidingly engage an upper track;
a lower member including a second housing having a generally U-shaped channel running along an inner side of the housing configured to receive a lower edge portion of the sliding window sash,
wherein the second housing includes at least one roller extending from an outer side opposing the inner side of the second housing, the roller configured to slidingly engage a lower track; and
an interlock assembly having a first interlock part configured to be secured to a fixed panel and having a second interlock part configured to be secured to the sliding window sash, the second interlock part configured to engage the first interlock part upon slidably closing the sliding window to thereby inhibit lateral movement of the sliding door out of the track.

11. The security sliding door of claim 10, further comprising a locking assembly comprising:
a striker plate configured to be secured to a door jamb, the striker plate configured to provide a striking surface for the sliding window sash when closed; and
a locking apparatus mounted on an edge of the sliding window sash, the locking apparatus having at least one locking peg extending toward the striker plate,
wherein the striker plate includes at least one slot aligned with the locking peg, the slot configured to receive the at least one locking peg from the sliding window sash, and
wherein the at least one locking peg is vertically slidable relative to the window sash to thereby removably lock the locking peg into the slot.

12. The security sliding door of claim 11, wherein the locking peg has a mushroom headed configuration.

13. The security sliding door of claim 12, further comprising a generally L-shaped lift protector configured to be secured to a corner of a frame into which the sliding window sash is receivable, the lift protector configured to inhibit removal of the sliding window from the track by preventing insertion of a tool beneath the sash.
